(19) United States
(12) Patent Application Publication
(10) Pub. No.: US 2012/0133253 A1
(43) Pub. Date: May 31, 2012

(54) FURNITURE KIT

(76) Inventors: Louis Bergevin, Notre-Dame-de-l'ile-Perrot (CA); Annie Lajeunesse, Hudson (CA)

(21) Appl. No.: 12/954,652

(22) Filed: Nov. 25, 2010

(51) Int. Cl. A47B 96/20; B23P 11/00; A47B 97/00; A47B 96/00; A47B 95/02

(52) U.S. Cl. 312/204; 312/351.1; 312/326; 29/428

(57) ABSTRACT

The present document describes a furniture kit for building a furniture assembly comprising: a) two side walls, each side wall having a first end with a mating connector and a second end with a mating connector; and b) at least one of a top wall or a bottom wall, each having a first end with a mating connector and a second end with a mating connector, the top wall or bottom wall releasable connecting with each of said at least one end of said side wall.

### BACKGROUND

(a) Field

The subject matter disclosed generally relates to a furniture kit for releasably assembling a furniture assembly and a method of building a furniture thereof.

(b) Related Prior Art

Typically, in the field of do-it-yourself furniture assembly, it is possible to purchase furniture kits from suppliers which will fabricate the furniture members in their own workshop and deliver the product in a non-assembled form. Unfortunately, usually the establishment of these assemblies by the consumer usually requires the use of a screwdriver or any other tool. Also, these types of furniture assembly kits provide the members to be assembled and the mating connectors separately, which result in a difficult establishment of the furniture without the help of a second or of a third person. These types of furniture kits do not work satisfactory because it cannot be established easily or quickly by the consumer.

As an example, U.S. Pat. No. 6,045,290 (IKEA International NS) recites a corner joint type especially for joining furniture parts. This construction enables the members of the furniture to be easily separated without damaging the members. However, it does not provide a furniture kit for releasably assembling furniture members, where the furniture members already include mating connectors, and a method for releasably assembling furniture members, where the furniture members already include mating connectors.

For those disadvantages, there is still a need in the field of furniture assembly kits to be assembled by a consumer in its home.

### SUMMARY

According to an embodiment, there is provided a furniture kit for building a furniture assembly comprising:

a) two side walls, each side wall having a first end with a mating connector and a second end with a mating connector; and

b) at least one of a top wall or a bottom wall, each having a first end with a mating connector and a second end with a mating connector, said top wall or bottom wall releasably connecting with each of said at least one end of said side wall,

The two side walls mating connectors may be releasably connecting to each other,

The furniture kit may also include a top wall and a bottom wall.

The furniture kit may also include a rear wall having a first end with a mating connector and a second end with a mating connector, said rear wall releasably connecting with a mating connector on at least two end selected from the side wall first and second ends; the top wall first and second ends; and the bottom wall first and second ends.

The furniture kit may also include a board-like member having a first end and a second end releasably connecting with a mating connector on each of said side walls. The mating connectors on the side walls may be securely holding said board-like member therebetween.

The furniture kit may also include a front wall having at least one end with a mating connector releasably connecting with one end of said side walls. The mating connector on the front wall may be a hinge. The front wall may be a door, optionally the door may be hingedly connected to a decorative frame assembly. The front wall may be further adapted to receive an implement such as a handle, a lock, a sliding lock, and combination thereof.

The mating connectors may be false-tenon and mortise.

The mating connectors may be a tenon for interfacing with a corresponding mortise, a mortise for interfacing with a corresponding false tenon, a mortise for interfacing with a corresponding through tenon, a double mortise for interfacing with a corresponding double tenon, a mortise for interfacing with a corresponding pegged tenon, and a mortise for interfacing with a corresponding pegged false tenon, profile for interfacing with a corresponding counter profile, a finger joint for interfacing with a corresponding finger joint, a tongue for interfacing with a corresponding grove, and a slot for interfacing with a corresponding biscuit or any combinations thereof.

The furniture kit may also include a molding on one wall, the molding with mating connector releasably connecting with said at least one wall of the furniture assembly.

The walls may be made with at least one material selected from the group consisting of: wood, polymeric material or melamine.

According to another embodiment, there is provided a method for building a furniture assembly comprising:

a) releasably connecting a mating connector of an end of a first side wall with a mating connector of an end of the top wall or the mating connector of an end of the bottom wall; and

b) releasably connecting the mating connector of an end of a second side wall with at least one of the mating connector of an end of the top wall or the mating connector of an end of the bottom wall.

The method may further include the following steps :

c) releasably connecting the mating connector of an end of a rear wall with a mating connector of an end of a first side wall; and

d) releasable connecting the mating connector of an end of a rear wall with at least one of the mating connector of an end of a second side wall.

The method may further include the following step:

e) releasably connecting the mating connector of an end of a door wall with at least one of the mating connector of an end of a side wall.

According to another embodiment, there is provided a method for building a furniture assembly comprising:

a) releasable connecting a mating connector of a first end of a first side wall with a mating connector of a first end of the bottom wall;

b) releasably connecting a mating connector of a first end of a rear wall with a mating connector of an end of the first side wall and with a mating connector of an end of the bottom wall;

c) releasably connecting a mating connector of a second end of the rear wall with a mating connector of an end of the first side wall;

d) releasably connecting the mating connector of a first end of a second side wall with a mating connector of a second end of the top wall and with the mating connector of a second end of the bottom wall;

e) releasable connecting at least one board-like member in between a mating connector of the first side wall the second side wall; and

f) releasably connecting the mating connector of a first end of a front wall with at least one of the mating connector of an end of the first side wall,

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a perspective view of a furniture assembly in accordance with an embodiment.

FIG. 2 is a perspective view of a furniture assembly in accordance with another embodiment.

FIG. 3A is a perspective view of a one-door top wall furniture assembly in accordance with another embodiment.

FIG. 3B is a perspective view of a two-door top wall furniture assembly in accordance with another embodiment.

FIG. 3C is a perspective view of a two-door top wall furniture assembly n accordance with another embodiment.

FIG. 3D is a perspective view of a two-door top wall furniture assembly in accordance with another embodiment.

FIG. 3E is a perspective view of a one-door top wall corner furniture assembly in accordance with another embodiment.

FIG. 3F is a perspective view of a one-door top wall corner furniture assembly in accordance with another embodiment.

FIG. 3G is a perspective view of a two-door furniture assembly in accordance with another embodiment.

FIG. 3H is a perspective view of a furniture assembly in accordance with another embodiment, and more specifically, FIG. 3h is a perspective view of.

FIG. 3I is a perspective view of a one-door bottom wall furniture assembly in accordance with another embodiment.

FIG. 3J is a perspective view of a two-door bottom wall furniture assembly in accordance with another embodiment.

FIG. 3K is a perspective view of a two-door bottom wall corner furniture assembly in accordance with another embodiment.

FIG. 3L is a perspective view of a one-door bottom wall corner furniture assembly in accordance with another embodiment.

FIG. 3M is a perspective view of a four-drawer bottom wall furniture assembly in accordance with another embodiment.

FIG. 3N is a perspective view of a one-door bottom wall furniture assembly in accordance with another embodiment.

FIG. 3O is a perspective view of a two-door bottom wall furniture assembly in accordance with another embodiment.

FIG. 3P is a perspective view of a three-drawer bottom wall furniture assembly in accordance with another embodiment.

FIG. 3Q is a perspective view of a one-door medicine cabinet furniture assembly in accordance with another embodiment.

FIG. 3R is a perspective view of a two-door washstand furniture assembly in accordance with another embodiment.

FIG. 3S is a perspective view of a one-door linen cabinet or pantry cabinet furniture assembly in accordance with another embodiment.

FIG. 3T is a perspective view of a two-door linen cabinet or pantry cabinet furniture assembly in accordance with another embodiment.

FIG. 4 is a perspective view of a molding to be installed on any furniture assembly in accordance with another embodiment.

It will be noted that throughout the appended drawings, like features are identified by like reference numerals.

### DETAILED DESCRIPTION OF THE PREFERRED EMBODIMENTS

In embodiments there are disclosed a kit for releasably assembling a furniture assembly.

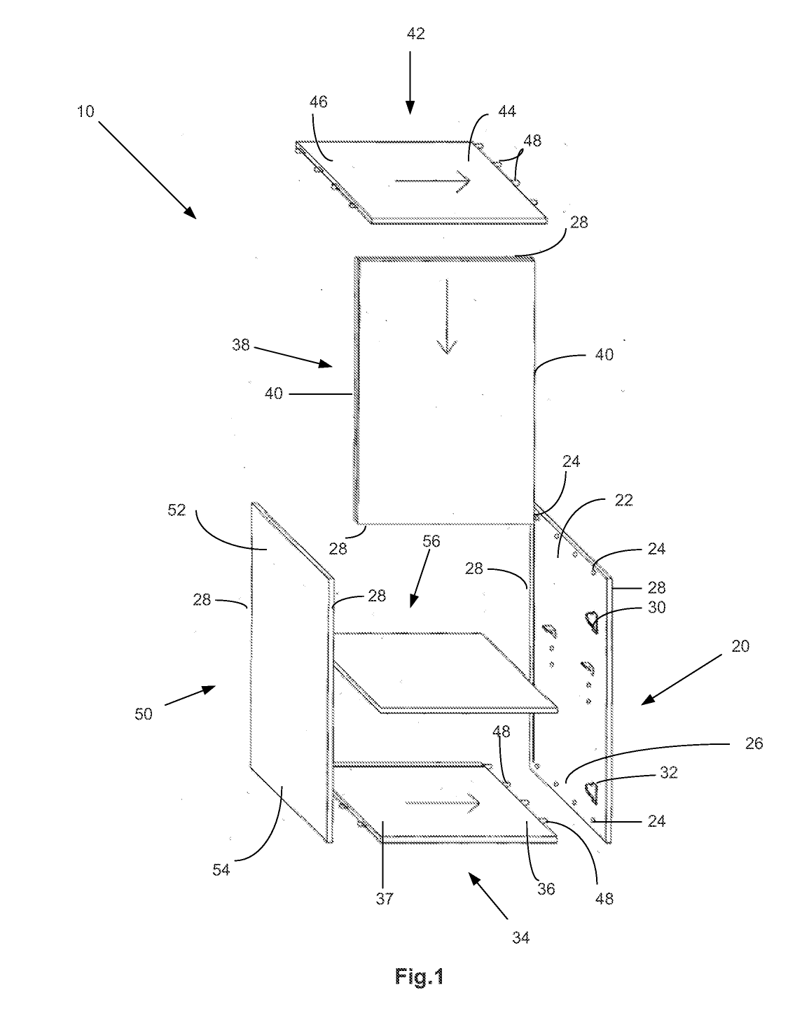

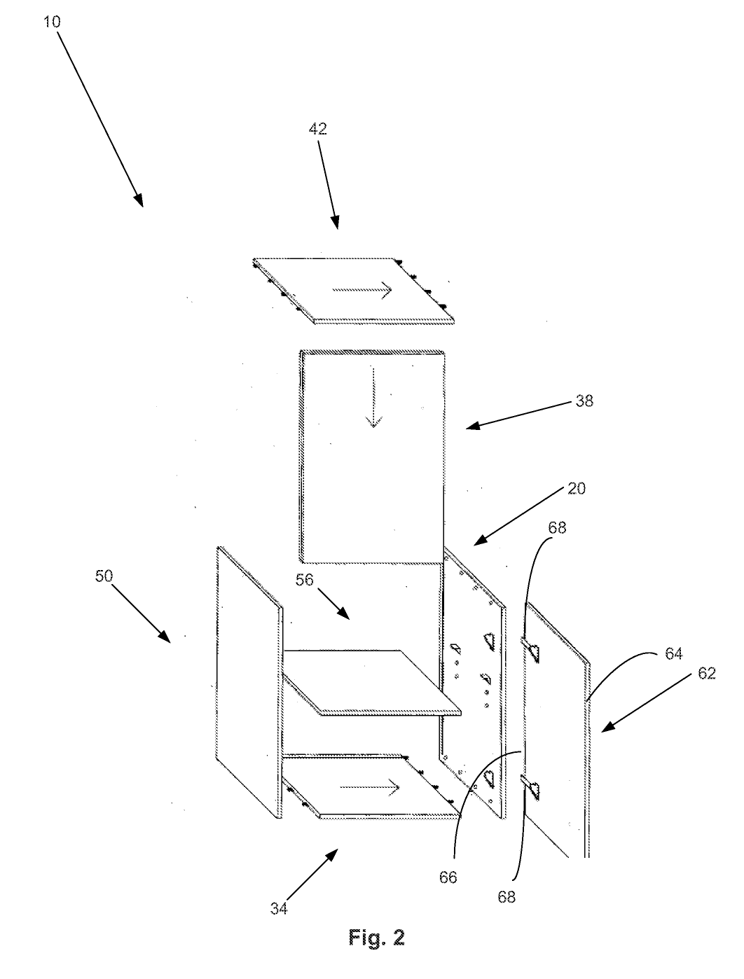

Referring now to the drawings, and more particularly to FIGS. 1 and 2, there is shown a furniture kit 10 for building a furniture assembly having two side walls. The furniture kit 10 having a first side wall 20 and a second side wall 50. The first side wall 20 of the furniture kit 10 having a first end 22 using mating connectors 24 and a second end 26 using mating connectors 24.

Still referring to FIGS. 1 and 2, the furniture assembly 10 may also include at least one of a top wall 42 or a bottom wall 34. The top wall 42 of the furniture kit 10 has a first end 44 using mating connectors 48 and a second end 46 using mating connectors 48. The top wall 42 or the bottom wall 34 of the furniture kit may be releasably connected with at least one end 22 or 26 of the first side wall 20 or with at least one end 52 or 54 of the second side wall 50.

Moreover, the first side wall 20 having at least one side edge 28 and the second side wall 50 having at least a side edge 28 may be releasably connecting along a longitudinal respective side edges 28.

Also, the furniture assembly 10 may include a top wall 42 and a bottom wall 34.

The furniture assembly 10 may also include a rear wall 38 using mating connectors 28, 40. The rear wall 38 may be releasably connecting with one of the group consisting of:

at least one end 22, 26, 52 or 54 of a side wall 20 or 50 or with at least one end 36, 37, 44 or 46 of the top wall 42 or the bottom wall 34;

at least one end 22, 26, 52 or 54 of a side wall 20 or 50 and at least one end 36, 37, 44 or 46 of a top wall 42 or a bottom wall 34; and

at least two ends 22, 26, 52 or 54 of a side wall 20 or 50.

Moreover, the furniture assembly 10 may further include a board-like member 56. The board-like member 56 may be releasably connected with at least one end 22, 26, 52 or 54 of the side walls 20 or 50.

Furthermore, the furniture assembly 10 may include a front wall 20 having an end using mating connector. The front wall 20 may be releasably connected with one end 22, 26, 52 or 54 of said side wall 20 or 50. It is to be noted that the furniture assembly 10 may include hinges as mating connectors,

In the furniture assembly 10, the front wall may be a door.

In the furniture assembly 10, the mating connectors may be, without limitations, false-tenon and mortise, edges and longitudinal projections, dovetail joints hinges and the like, or any combinations thereof.

The furniture assembly kit may be assembled using any one of a number of suitable jointing methods known to the person of skill in the art. For example, the mating connectors may be a tenon for interfacing with a corresponding mortise. Preferably, the mating connectors may be mortises on each of the member for interfacing with a corresponding false tenon. Other suitable jointing methods include as mating connector a mortise for interfacing with a corresponding through tenon, a double mortise for interfacing with a corresponding double tenon, a mortise for interfacing with a corresponding pegged tenon, and a mortise for interfacing with a corresponding pegged false tenon, a profile for interfacing with a corresponding counter profile, a finger joint for interfacing with a corresponding finger joint, a tongue for interfacing with a corresponding grove, and a slot for interfacing with a corresponding biscuit, or any combinations thereof.

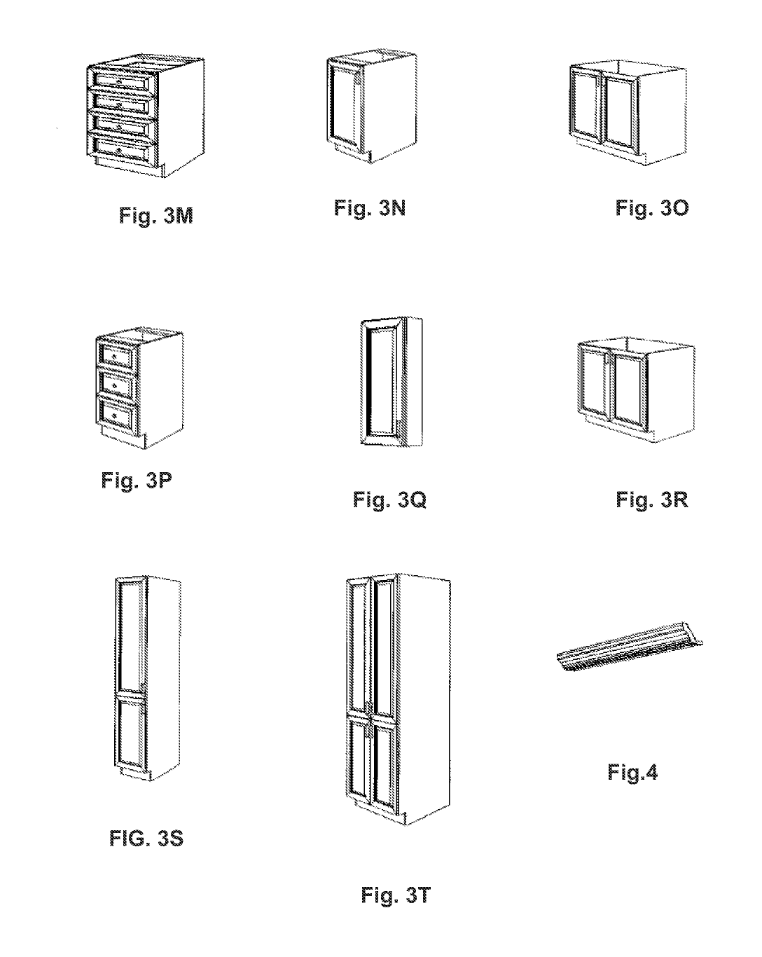

Finally, in the furniture assembly 10, the walls 20, 34, 38, 42, 50 and 62 may include molding 100, as shown in FIG. 4. The molding 100 may be releasably connecting with the wall using mating connectors as defined above.

The furniture kit of claim 2, wherein said walls are made, for example, with a material selected from the group consisting of: wood, polymeric material or melamine.

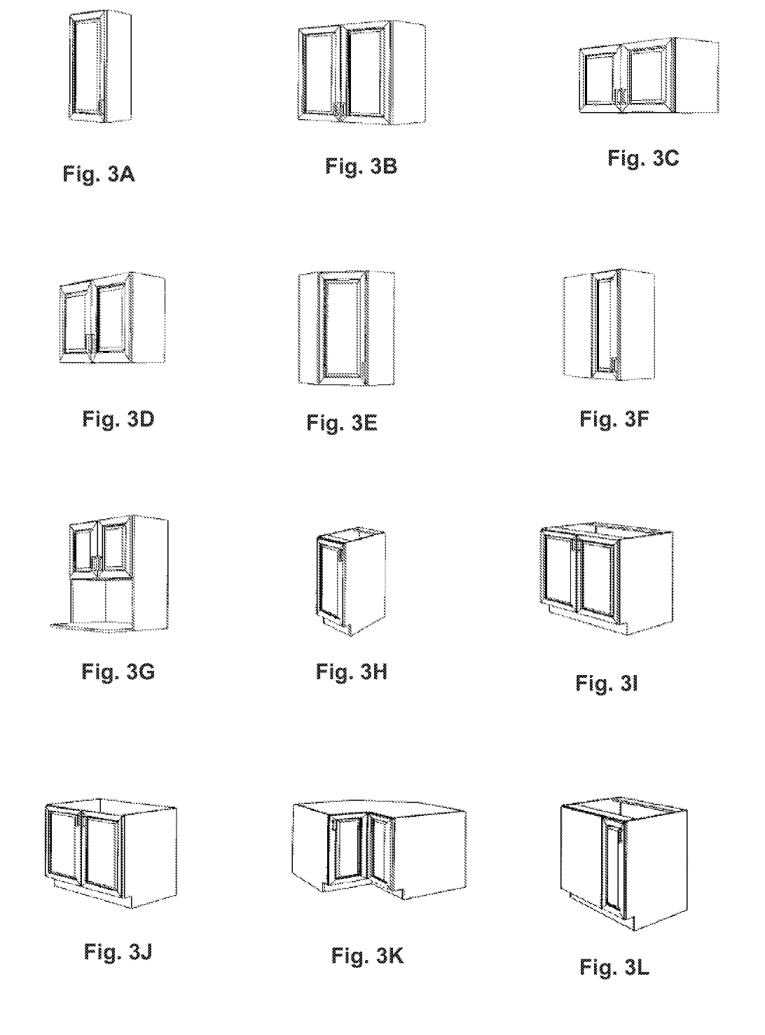

in FIGS. 3A to 3T, there is shown multiple examples of a furniture assembly in accordance with embodiments. The furniture assembly may be selected from the following examples: a one-door top wall furniture assembly, a two-door top wall furniture assembly, a two-door top wall furniture assembly, a one-door top wall corner furniture assembly, a two-door furniture assembly for fitting a microwave, a one-door bottom wall furniture assembly, two-door bottom wall furniture assembly, a two-door bottom wall corner furniture assembly, one-door bottom wall corner furniture assembly, a four-drawer bottom wall furniture assembly, a three-drawer bottom wall furniture assembly, a one-door medicine cabinet furniture assembly, a two-door washstand furniture assembly, a one-door linen cabinet or pantry cabinet furniture assembly, a two-door linen cabinet or pantry cabinet furniture assembly, a cabinet, a pantry cabinet, a dishwasher cabinet, a refrigerator cabinet, a linen cabinet, a dresser, a kitchen cabinet and the like, among others.

The present invention will be more readily understood by referring to the following examples which are given to illustrate the invention rather than to limit its scope.

### EXAMPLE 1

Furniture Assembly Kit

Example 1 defines a furniture kit as shown in FIGS. 1 and 2. One kit for building a furniture assembly 10 in accordance with one embodiment includes:

a first side wall 20, the first side wall 20 having a first end 22, a second and 26, a first hinge and a second hinge 30, 32 already installed and a side edge 28, both the first end 22 and the second end 26 of the first side wall 20 having a plurality of aperture 24;

a bottom wall 34, the bottom wall 34 haying a first end 36 and a second end 37, both the first end 36 and the second end 37 of the bottom wall 34 haying a securing means 48 already installed;

a rear wall 38 having longitudinal projections 40;

a top wall 42, the top wall 42 haying a first end 44 and a second and 46, both the first end 44 and the second end 46 of the top wall 42 having securing means 48 already installed;

a second side wall 50, the second side wall 50 having a first end 52, a second end 54 and a side edge 28, both the first end 52 and the second end 54 of the second side wall 50 having a plurality of aperture 24;

a board-like member 56, the board-like member 56 having a first end 58, a second end 60: and

a front wall 62 having a first end 64, a second end 66 and attaching means 68 already installed.

### EXAMPLE 2

Building a Furniture Assembly

One can easily assemble a furniture assembly using a furniture kit of Example 1 as shown in FIGS. 1 and 2. One method for building a furniture assembly 10 in accordance with one embodiment includes the following steps:

a) laying down a first side wall 20 on a relatively flat surface.

b) connecting the bottom wall 34 with the first side wall 20;

c) connecting the rear wall 38 with the bottom wall 34;

d) connecting the top wall 42 with the first side wall 20;

e) connecting the second side wall 50 with the bottom wall 34 and connecting the second side wall 50 with the top wall 42;

f) connecting a board-like member 56 in between the first side wall 20 and the second side wall 50 of the furniture assembly 10; and

g) connecting the front wall 62 with the first side wall 20 and connecting the front wall 62 with the first side wall 20.

The resulting furniture assembly can be easily disassembled without damaging any pieces. The disassembled furniture assembly can be easily moved or stored with a view to be reassembled at a later date.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A furniture kit for building a furniture assembly comprising:
a) two side walls, each side wall having a first end with a mating connector and a second end with a mating connector; and
b) at least one of a top wall or a bottom wall, each haying a first end with a mating connector and a second end with a mating connector, said top wall or bottom wall releasably connecting with each of said at least one and of said side wall.

2. The furniture kit of claim 1, wherein said two side walls mating connectors are releasably connecting to each other.

3. The furniture kit of claim 1, comprising a top wall and a bottom wall.

4. The furniture kit of claim 3, further comprising a rear wall haying a first end with a mating connector and a second end with a mating connector, said rear wall releasably connecting with a mating connector on at least two end selected from the side wall first and second ends; the top wall first and second ends; and the bottom wall first and second ends.

5. The furniture kit of claim 3, further comprising a board-like member haying a first end and a second end releasably connecting with a mating connector on each of said side walls.

6. The furniture kit of claim 3, further comprising a front wall having at least one end with a mating connector releasably connecting with one end of said side walls.

7. The furniture kit of claim 6, wherein said mating connector on said front wall is a hinge.

8. The furniture kit of claim 6, wherein the front wall is a door.

9. The furniture kit of claim 6, wherein said front wall is further adapted to receive an implement.

10. The furniture kit of claim 9, wherein said implement is selected from the group consisting of: a handle, a lock, a sliding lock, and combination thereof.

11. The furniture kit of claim 6, wherein said mating connectors on said side walls are securely holding said board-like member therebetween.

12. The furniture kit of claim 1, wherein the mating connectors are false-tenon and mortise.

13. The furniture kit of claim 1, wherein at least one wall comprises a molding, said molding with mating connector releasably connecting with said at least one wall of the furniture assembly.

14. The furniture kit of claim 1, wherein said walls are made with at least one material selected from the group consisting of: wood, polymeric material or melamine.

15. The furniture kit of claim 1, wherein said mating connector is a tenon for interfacing with a corresponding mortise.

16. The furniture kit of claim 1, wherein said mating connector is a mortise for interfacing with a corresponding false tenon.

17. The furniture kit of claim 1, wherein said mating connector is chosen from a mortise for interfacing with a corresponding through tenon, a double mortise for interfacing with a corresponding double tenon, a mortise for interfacing with a corresponding pegged tenon, and a mortise for interfacing with a corresponding pegged false tenon or any combinations thereof.

18. The furniture kit of claim 1, wherein said mating connector is a profile for interfacing with a corresponding counter profile, a finger joint for interfacing with a corresponding finger joint, a tongue for interfacing with a corresponding grove, and a slot for interfacing with a corresponding biscuit or any combinations thereof.

19. The furniture kit of claim 1, wherein said door assembly is hingedly connected to a decorative frame assembly.

20. A method for building a furniture assembly comprising the step of:
assembling the kit of claim 1.

21. A method for building a furniture assembly comprising;
a) releasable connecting a mating connector of an end of a first side wall with a mating connector of an end of the top wall or the mating connector of an end of the bottom wall; and
b) releasably connecting the mating connector of an end of a second side wall with at least one of the mating connector of an end of the top wall or the mating connector of an end of the bottom wall.

22. The method for building a furniture assembly of claim 21, further comprising;
c) releasably connecting the mating connector of an end of a rear wall with a mating connector of an end of a first side wall; and
d) releasable connecting the mating connector of an end of a rear wall with at least one of the mating connector of an end of a second side wall.

23. The method for building a furniture assembly of claim 22, further comprising:
e) releasably connecting the mating connector of an end of a door wall with at least one of the mating connector of an end of a side wall.

24. A method for building a furniture assembly comprising:
a) releasably connecting a mating connector of a first end of a first side wall with a mating connector of a first end of the bottom wall;
b) releasably connecting a mating connector of a first and of a rear wall with a mating connector of an and of the first side wall and with a mating connector of an end of the bottom wall;
c) releasably connecting a mating connector of a second end of the rear wall with a mating connector of an end of the first side wall;
d) releasably connecting the mating connector of a first end of a second side wall with a mating connector of a second end of the top wall and with the mating connector of a second end of the bottom wall;
e) releasably connecting at least one board-like member in between a mating connector of the first side wall the second side wall; and
f) releasably connecting the mating connector of a first end of a front wall with at least one of the mating connector of an end of the first side wall.
